(19) United States
(12) Patent Application Publication
(10) Pub. No.: US 2008/0183997 A1
(43) Pub. Date: Jul. 31, 2008

(54) Storage library with removable media

(76) Inventors: Curtis C. Ballard, Eaton, CO (US); John G. McCarthy, Fort Collins, CO (US); Steven Maddocks, Windsor, CO (US); Stanley S. Feathers, Longmont, CO (US); Michael Banther, Badminton (GB); Andrew Damian Topham, Dursley (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/700,604

(22) Filed: Jan. 31, 2007

(51) Int. Cl. G06F 12/00

(52) U.S. Cl. 711/163

(57) ABSTRACT

Embodiments include methods, apparatus, and systems for managing a storage library with removable media. One method includes providing to an administrative console identification of host computers attempting to access a tape drive in a tape library; determining, from input at the administrative console, access rights for each of the host computers attempting to access the tape drive; and transmitting the access rights to the tape drive in order to configure the tape drive to determine which of the host computers are authorized to access the tape drive.

### BACKGROUND

Storage automation systems, such as data cartridge storage systems, include a host computer and a data storage device. The data storage device typically comprises a cartridge storage element, input/output (I/O) components, and a moveable cartridge access component, sometimes referred to as a “picker.” The cartridge storage element stores a plurality of data cartridges in an array, and each data cartridge in the array has an associated storage position within the cartridge storage element.

During operation, the data storage device receives from the host computer a request for retrieval of a specified data cartridge. The storage device determines, based on the request received from the host computer, a data cartridge position for the requested data cartridge. The movable cartridge access device then moves to that position, retrieves the requested cartridge from the cartridge storage element, moves to the position of an I/O component, for example, a data cartridge drive, and loads the data cartridge into the data cartridge drive.

Typically, the data storage device further comprises a controller that is configured to receive requests, such as the cartridge retrieval requests described above, from the host computer and manage the operation of the device in response to the requests. During operation of the storage device, the controller may retain operational information that is used by the controller for operation and management of the device. A data storage device may also comprise a separate management controller that is configured to receive requests such as configuration settings or cartridge retrieval requests from a management computer or a person at a management console.

Owners or administrators of storage systems desire to efficiently manage and regulate access to resources in the storage system.

### BRIEF DESCRIPTION OF THE DRAWINGS

FIG. 1 is a storage system having a cartridge library in accordance with an exemplary embodiment of the present invention.

FIG. 2 is a management component for a cartridge library in accordance with an exemplary embodiment of the present invention.

FIG. 3 is an exemplary flow diagram for controlling access to storage devices in a storage system in accordance with an exemplary embodiment of the present invention.

FIG. 4 is an exemplary storage system having a tape library in accordance with an exemplary embodiment of the present invention.

FIG. 5A is a perspective view of a tape drive in accordance with an exemplary embodiment of the present invention.

FIG. 5B is a rear plan view of the tape drive of FIG. 5A in accordance with an exemplary embodiment of the present invention.

### DETAILED DESCRIPTION

Embodiments in accordance with the present invention are directed to apparatus, systems, and methods for managing automated storage systems. In one exemplary embodiment, a method is implemented in storage device firmware so the storage device can report over a management interface all of the different hosts that attempt to access the storage device. The management interface sends commands to the storage device specifying which hosts have access to the storage device. In one exemplary embodiment, the storage device by default does not allow any access so a management or administrative device is used to add hosts to and remove hosts from an access list.

The management device provides a user interface that presents a view of all storage devices found in the system and all of the hosts that are available for communicating with those storage devices. Through interaction with the interface, a user or administrator can specify which hosts are authorized to communicate with which storage devices. Once the user configuration is complete, the management appliance transmits the data (i.e., privileges or authorization) to the appropriate drives to configure them.

One exemplary embodiment provides a dedicated management port on a removable media device, such as a tape drive. This management port enables the media device to be managed by a separate electronic device that is not tightly integrated into the physical environment where the media device is located and installed. The management port enables an administrator to remotely control the media device regardless of other software or hardware. For instance, in many tape libraries, the individual tape drives are tightly integrated into a system where access to the tape drive requires support from either a hardware device or software that is provided by a third party (example, vendor). Embodiments in accordance with the present invention can directly access the tape drive through the management port without multiple integrations with such third party hardware and software.

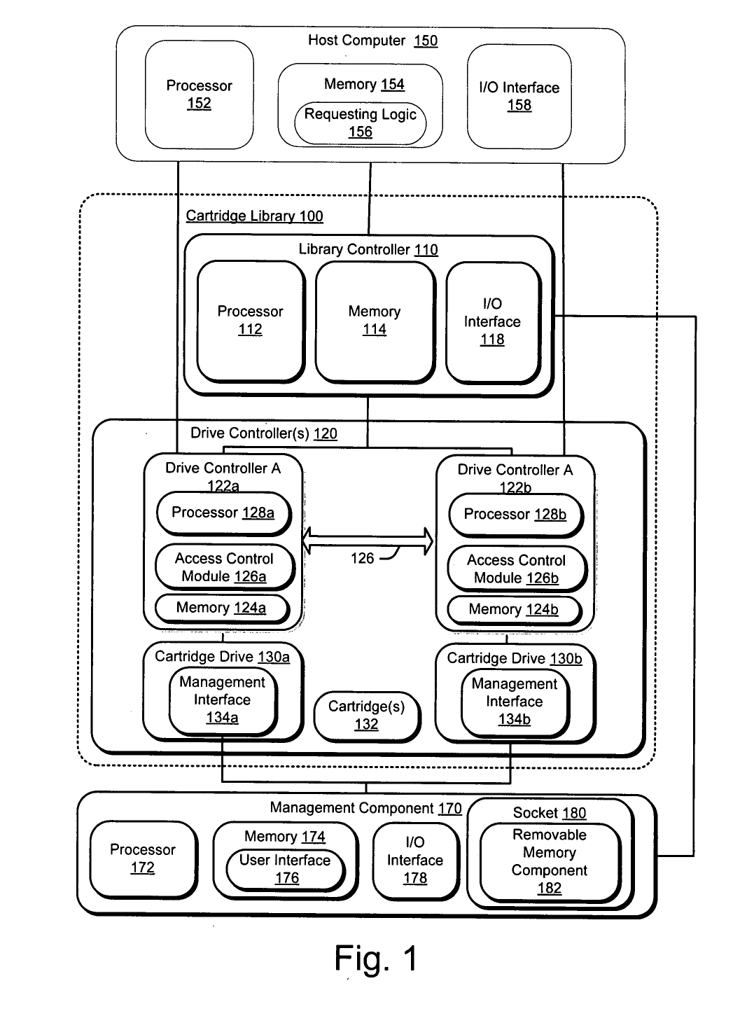

FIG. 1 is an exemplary storage system having a cartridge library 100 in accordance with an exemplary embodiment of the present invention. In one embodiment, the cartridge library 100 is a tape library that includes at least one library controller module 110, including a processor 112 which is coupled to a memory 114, an I/O interface 118, and one or more cartridge drive controllers 120. The library controller 110 is coupled to the cartridge drive controllers 120 via one or more interface buses such as, e.g., an RS422 bus or an inter-integrated circuit (I2C) bus. It is noted that the library controller 110 can be embodied as a separate component (as shown), or can be co-located with one or more of the driver controllers 120, or within a separate host computer 150.

In one embodiment, the library controller 110 is implemented as a software module that runs on a general purpose processing unit of the tape library, or as a special-purpose chipset.

In some embodiments, the host computers 150 connect to the drive controllers and the library controller by another bus. By way of example, the host computers 150 connect to the library and drives using SCSI, and the library connects to the drives using RS422.

The cartridge drive controllers 120 coordinate data transfer to and from the one or more cartridge drives 130a-130b. In one embodiment, the library includes two cartridge drive controllers: a first cartridge drive controller 122a and a second cartridge drive controller 122b. The controllers may operate independently or may be configured to operate in parallel to enhance reliability by providing continuous backup and redundancy in the event that one controller becomes inoperable. Cartridge drive controllers 122a and 122b have respective processors 128a and 128b, respective memories 124a and 124b, and respective access control modules 126a and 126b. Processors 128a, 128b can be implemented as general purpose processors that execute logic instructions in the respective memories 124a, 124b, or can be implemented as special purpose processors adapted to implement logic instructions embodied as firmware, or as ASICs. The memories 124a and 124b can be implemented as battery-backed, non-volatile RAMs (NVRAMs). Although only two controllers 122a and 122b are shown and discussed generally herein, aspects of this invention can be extended to other multi-controller configurations where more than two controllers are employed.

The cartridge drives 130a, 130b are configured to receive a tape cartridge 132. Input/Output (I/O) operations requested by host computer 150 are executed against data stored in the tape cartridges 132.

In some embodiments, tape library 100 is coupled to a management component 170. Management component 170 is embodied as an integrated computing device such as, e.g., a blade server implemented on a printed circuit board (PCB) that couples to an expansion slot in tape library 100. Alternatively, management component 170 is embodied as a stand-alone computing device such as, e.g., a server, coupled to tape library 100 via a communication link, such that management component 170 is coupled to multiple tape libraries 100.

Management component 170 includes a processor 172, a memory module 174, and an I/O interface 178. Processor 172 can be embodied as a general purpose computer processor. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Memory 174 includes one or more of random access memory (RAM), dynamic RAM (DRAM), synchronous DRAM (SDRAM), and the like. For example the memory 174 includes an operating system to manage operations of management component 170. The operating system can include (or manage) one or more communication interfaces such as I/O interface 178 to receive data packets and/or data streams from a remote source. The I/O interface 178 can include a parallel port (e.g., a small computer system interface (SCSI) port), Ethernet, or other type of known or future developed data communication port.

In some embodiments management component 170 includes a removable non-volatile memory component (RNMC) 182 coupled via a socket 180 that provides a conductive connection between the RNMC 182 and other components of the management component 170. The RNMC 182 can store operational and control management data associated with the tape library 100.

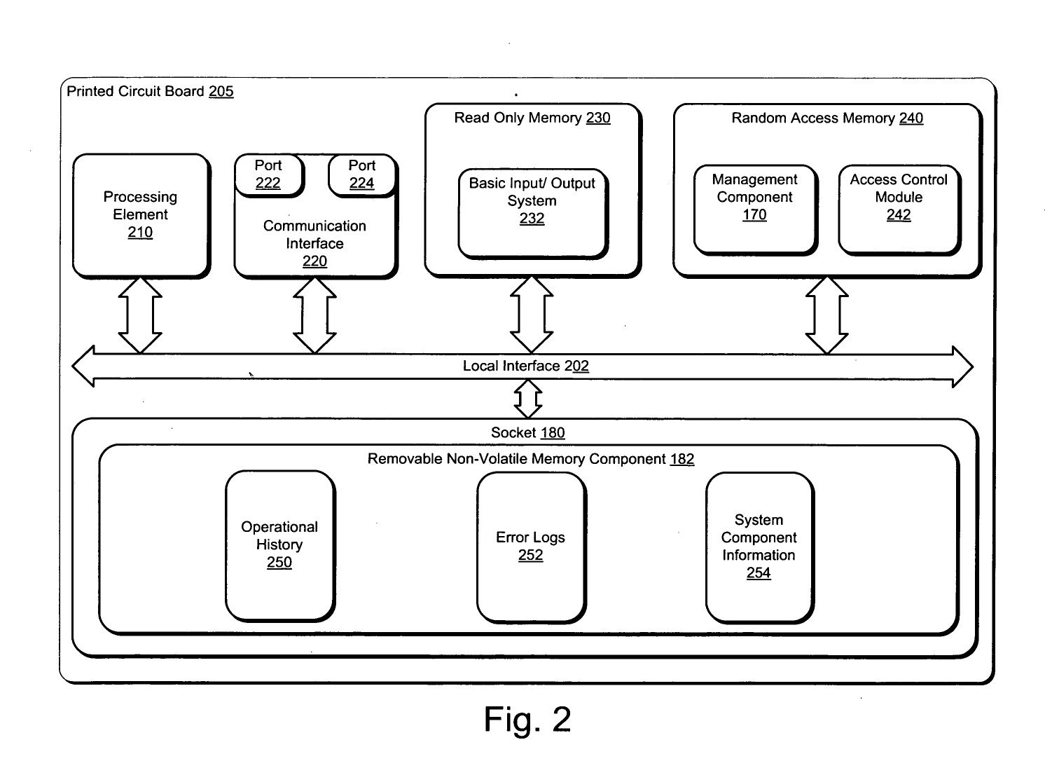

FIG. 2 is a schematic illustration of an embodiment of the management component 170 shown in FIG. 1. Referring to FIG. 2, the management component is mounted on a circuit board 205. Management component 170 (see FIG. 1) comprises one or more system processing elements 210, such as a digital signal processor (DSP) or a central processing unit (CPU) that communicates with other elements within the management component 170 via a local interface 202, which can include one or more buses. Management component 170 further comprises read-only memory (ROM) 230 storing a basic input/output system (BIOS) 232 and random access memory (RAM) 240 storing management component 170 and access control module 242.

Circuit board 205 further comprises a communication interface 220, which in turn comprises one or more ports 222, 224. One of the ports 222 may be utilized to exchange data with the host computer 150. The other port 224 may be used to access information related to a cartridge drive 130a, 130b in tape library 100.

In some embodiments the management component 170 is implemented as an integral component of tape library 100. In other embodiments, the management component 170 is integrated as a separate computing device that is geographically located remote from the storage device and connected to the tape library 100 via a communication network. Further, management component 170 can couple to multiple tape libraries that are co-located in a single facility or geographically remote.

As illustrated by way of example in FIG. 2, management component 170 is implemented as logic instructions stored in a computer-readable medium such as, e.g., RAM 240. However, in other embodiments the logic 100 is implemented in hardware or a combination of hardware and software. The management component 170, when implemented in as logic instructions, can be stored and transported on any computer-readable medium for use by or in connection with an instruction execution system, apparatus, or device, such as a computer-based system, processor-containing system, or other system that can fetch and execute instructions.

As shown by FIG. 2, in some embodiments each of the components of the management component 170 can reside on a single printed circuit board (PCB) 205. However, in other embodiments, the management component 170 components reside on multiple PCBs and/or be interconnected via other types of known or future-developed devices. The PCB 205 can interface with the tape library 100 via an expansion slot, as a daughterboard or as a controller board or via a communication link.

In some embodiments the PCB 205 comprises a socket 180 to which the RNMC 182 is coupled. The RNMC stores an operation history 250, error logs 252, system component information 254, etc.

In storage area networks, there are a large number of host computers with access to all of the devices on the network in the default configuration. With prior tape devices, when a host on the network accesses the tape drive in the middle of a read or write operation, the host can cause a failure of the command. This can create a problem since the drive is unable to simply re-write or re-read that block because tape drives are sequential devices that cannot randomly position.

One exemplary embodiment solves this problem by removing the dependency on external hardware and moves access control into the storage device. In one embodiment, a method is implemented in the storage device firmware where the storage device reports over the management interface 134 all of the different hosts 150 attempting to access the storage device. By way of example, the hosts may be identified by use of a unique identifier assigned by a name address authority such as a World Wide Name (WWN), World Wide Identifier (WWI), or Medium Access Control (MAC). The management interface further sends commands to the storage device specifying which hosts are authorized to access the storage device. In one embodiment, the storage device will by default not allow any hosts to access unless the management device first adds or authorizes the host for such access. As such, access controls are implemented through the management component 170 and management interface 134.

The management component provides a user interface that presents a view of all of the storage devices found in the system and all of the hosts that are available for communication with those storage devices. An administrator has a simple-to-use interface to specify which hosts may communicate with which storage devices. Once the user configuration is complete, the management component transmits the data to the appropriate drives to configure them.

In one embodiment, a management port on the storage device is used to allow access by a management component directly to the storage device. Firmware on the management component and storage device configures the storage device to control access to a primary data port on that storage device. Thus, access to the primary data port is restricted to hosts that are specified by an administrator.

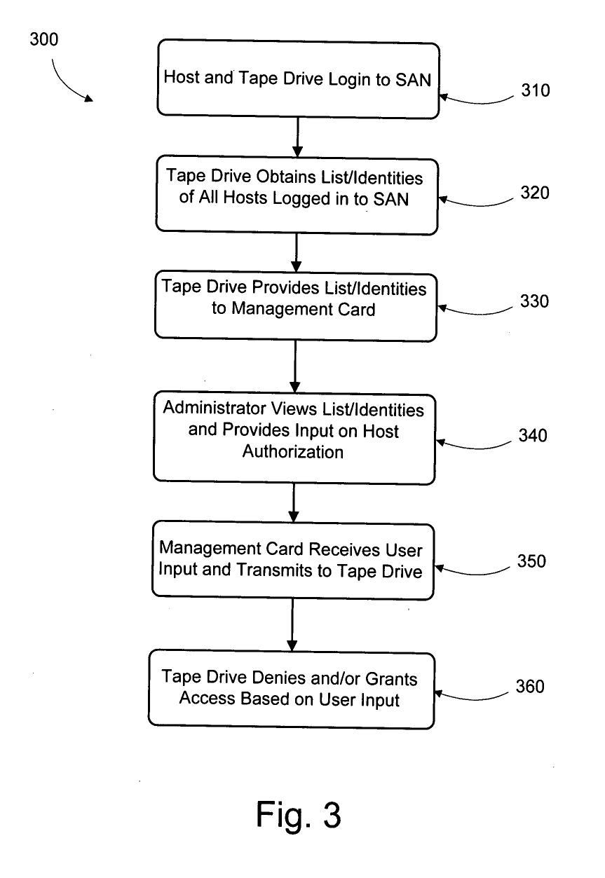

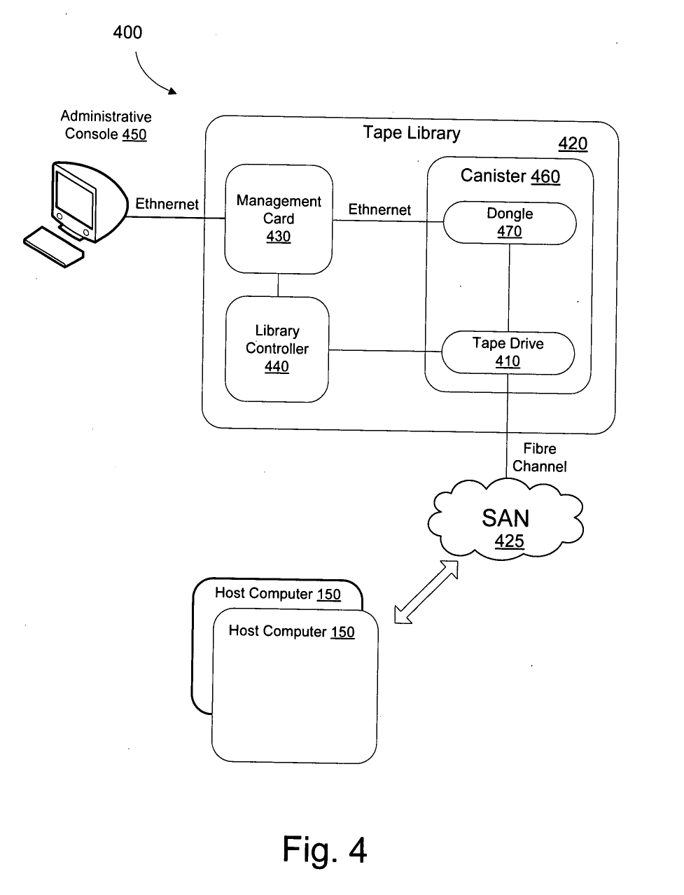

Exemplary embodiments in accordance with the invention are discussed in connection with FIGS. 3 and 4. Specifically, FIG. 3 is an exemplary flow diagram 300 for controlling access to storage devices in the storage system 400 of FIG. 4.

According to block 310, the host and the tape drive login to the network. By way of example, tape drive 410 of tape library 410 and plural hosts 150 log into storage area network (SAN) 425. For illustration, a fibre channel connection is shown between tape drive 410 and SAN 425

According to block 320, the tape drive obtains a list or identities of all hosts logged into the network. For example, the tape drive 410 determines which hosts 150 are requesting access to the tape drive.

According to block 330, the tape drive provides the list or identities to a management card. The management card can read out the identities, for example, from a table and provide this information through an interface to an administrator.

By way of example, tape drive 410 provides the names or identifications of the hosts to the management card 430. Information about hosts requesting access to the tape drive is provided through an interface to an administrative console 450.

According to block 340, a user or administrator views the list or identities of the hosts and provides input on host authorization. For instance, the administrator can determine that one or more hosts do or do not have authorization to access the tape drive.

By way of example, the administrative console 450 couples through a public Ethernet to management card 430. The management card couples through a private Ethernet to canister 460 and, in particular, dongle 470.

As used herein, a “dongle” is a hardware device that connects to an electronic device to control access to the electronic device and/or authenticate a piece of software. The dongle 470 controls access to one or more applications in the tape drive. For example, the dongle passes through all data coming to the port so the port is not used for unauthorized purposes.

According to block 350, the management card receives the input from the administrator and transmits this input to the tape drive. As shown in the FIG. 4, the management card 430 transmits the information to the tape drive 410 (example, a list of hosts that are authorized to access the tape drive).

According to block 360, the tape drive denies and/or grants access to the hosts based on the input from the administrator. For instance, the tape drive 410 maintains a list of hosts 150 that are authorized to perform reads, writes, and other tasks. If a host not on the list attempts to access the tape drive, then this host is denied access. In one exemplary embodiment, the tape drive maintains a list of all hosts that have been denied access and provides this list to the management card 430.

In one exemplary embodiment, an interface application in conjunction with the user interface 176 generates a graphical user interface for implementing the flow diagram of FIG. 3. The graphical user interface supports user interaction through common techniques, such as a pointing device (e.g., mouse, style), keystroke operations, touch screen, etc. For instance, a GUI at administrative console 450 enables a user or administrator to select and/or administer policies that manage host access to the storage device. The user is able to automatically obtain a list of host devices that are attempting to access the storage device. This list can also include other information, such as hosts currently authorized to access the storage device, hosts previously authorized and/or denied access, etc.

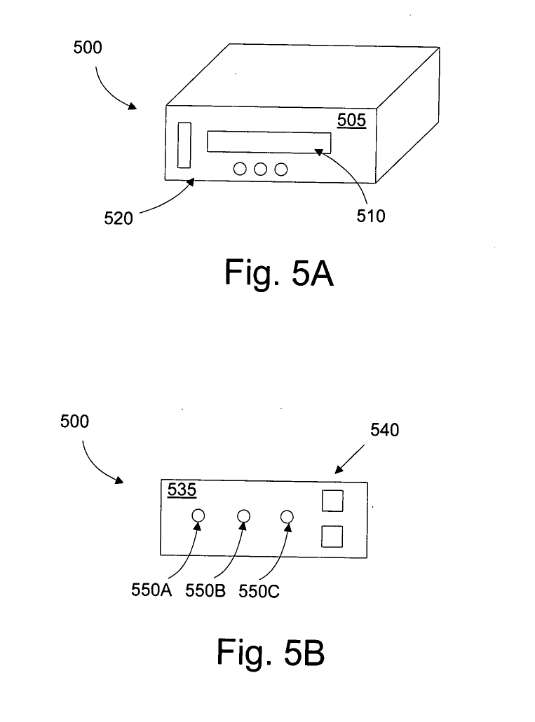

FIGS. 5A and 5B show one exemplary removable media device, such as a tape drive 500 in accordance with embodiments of the invention. Generally, the tape drive has a front side or panel 505 that includes a tape access door 510 and various controls and displays 520. A back side or panel 535 includes various connectors, ports, cable attachments, power, etc. (shown generally at 540).

In one exemplary embodiment, the tape drive 500 includes plural ports 550A-550C. At least one of these ports is a data port, and one port is a management port. The management and data ports are separately provided such that data can be managed without interfering with data traffic transmitting through the data port.

By way of example, a single management port 550A is provided on a removable media device, such as tape drive 500. This interface port is provided so that the tape drive can be managed by another device that is not tightly integrated into the environment where the tape drive is installed. As one example, if one or more tape drives 500 are installed in a rack or storage library (such as cartridge library 100), then a device (such as administrative console 450) can communicate and transmit management commands to the tape drive without interfering with data being transmitted to or from a host (such as host computer 150).

In one exemplary embodiment, the hardware and software for a control port at the tape drive are copied into a second module on the tape drive so that a duplicate of that port is made available to and additional functionality provided to a management appliance that is not integrated into the library hardware. Thus, one management appliance can connect directly to the management port on the tape drive.

In one exemplar embodiment, ports 550A-550C include one or more of a primary data port that connects to a host, an automation drive interface (ADI) port, and an automation management interface port (AMIP). The ADI port uses protocol defined by the InterNational Committee on Information Technology Standards (INCITS) T10 technical committee. The library controller 110 uses this port to communicate with the tape drive. The AMIP provides a new port that can be accessed from a management controller card imbedded in the library (example, management card 430). The AMIP may use any protocol suitable for use with a management port for example HTTP or SCSI.

Embodiments in accordance with the present invention are utilized in a variety of systems, methods, and apparatus. For instance, one or more computers or computer systems executes the flow diagram and/or aspects of exemplary embodiments in accordance with the present invention. Embodiments in accordance with the present invention are not limited to any particular type or number of computers or computer systems and include, but are not limited to, computers (portable and non-portable), servers, main frame computers, distributed computing devices, laptops, and other electronic devices and systems whether such devices and systems are portable or non-portable.

In one exemplary embodiment, one or more blocks in the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

In exemplary embodiments, the architectures and methods can be implemented in tape storage libraries such as the tape storage libraries described in U.S. Pat. No. 5,926,341; 6,028,733; or 6,421,306, commonly assigned to the assignee of the present application, the disclosures of which are incorporated by reference herein in their entirety.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
providing to an administrative console identification of host computers attempting to access a tape drive in a tape library;
determining, from input at the administrative console, access rights for each of the host computers attempting to access the tape drive; and
transmitting the access rights to the tape drive in order to configure the tape drive to determine which of the host computers are authorized to access the tape drive.

2) The method of claim 1 further comprising, transmitting the access rights through a management port on the tape drive, the management port being configured not to receive data from the host computers.

3) The method of claim 1 further comprising, obtaining by the tape drive a list of all host computers logged into a storage area network.

4) The method of claim 1 further comprising, determining by the tape drive which of the host computers are requesting access to the tape drive.

5) The method of claim 1 further comprising, providing to a management card in the tape library an identity of the host computers attempting to access the tape drive.

6) The method of claim 1 further comprising:
viewing at the administrative console a list of the host computers attempting to access the tape drive;
selecting from the list which host computer have access to the tape drive and which host computers do not have access to the tape drive.

7) A computer readable medium having instructions for causing a computer to execute a method, comprising:
providing to an administrative console a list of host computers requesting access to a tape drive in a tape library;
receiving, from the administrative console, access rights to the tape drive for the list of host computers; and
providing the access rights to the tape drive so the tape drive determines which of the host computers are authorized to access the tape drive.

8) The computer readable medium of claim 7 further comprising, updating the list to identify which of the host computers are authorized to access the tape drive and which of the host computers are not authorized to access the tape drive.

9) The computer readable medium of claim 7 further comprising, communicating the access rights through a management port on the tape drive, the management port provided to receive managing instructions from the administrative console but not data from the host computers.

10) The computer readable medium of claim 7 further comprising, displaying at the administrative console the list of host computers requesting access to the tape drive.

11) The computer readable medium of claim 7 further comprising, denying a host computer access to the tape drive until the tape drive receives authorization for that host from the administrative console.

12) The computer readable medium of claim 7 further comprising, maintaining at the tape drive identifications of host computers that are authorized to perform read and write operations at the tape drive.

13) The computer readable medium of claim 7 further comprising, maintaining at the tape drive identifications of host computer that are denied access to the tape drive.

14) The computer readable medium of claim 7 further comprising, managing access to the tape drive through the administrative console that is geographically remote from the tape library.

15) The computer readable medium of claim 7 further comprising, automatically providing from the tape drive to the administrative console names of host computers seeking to access the tape drive.

16) A storage system, comprising:
a tape drive having a first port and a second port, the first port receiving read and write requests from plural hosts connected to the tape drive through a storage area network, and the second port exclusively provided for managing the tape drive.

17) The storage system of claim 16, wherein the second port receives management commands from a management device but not configured to receive data from the plural hosts.

18) The storage system of claim 16 further comprising, a management appliance that directly connects to the second port for providing instructions to manage the tape drive.

19) The storage system of claim 16 further comprising, a management device providing an interface between the tape drive and an administrative console, wherein the management device (1) receives a list of host computers attempting to access the tape drive, (2) provides the list to the administrative console, (3) receives from the administrative console identities of host computers authorized to access the tape drive, and (4) provides the identities to the tape drive.

20) The storage system of claim 19, wherein the second port receives commands from a management console.
